(19) United States
(12) Patent Application Publication
(10) Pub. No.: US 2026/0025765 A1
(43) Pub. Date: Jan. 22, 2026

(54) IMAGING APPARATUS, POWER CONTROL METHOD, AND PROGRAM

(71) Applicant: Sony Group Corporation, Tokyo (JP)

(72) Inventor: Yoshikuni Sugita, Kanagawa (JP)

(21) Appl. No.: 18/699,787

(22) PCT Filed: Oct. 14, 2022
(86) PCT No.: PCT/JP2022/038416

§ 371 Date: Mar. 26, 2025

(30) Foreign Application Priority Data
Nov. 9, 2021 (JP) 2021-182300

(51) Int. Cl. H04W 52/02; H04N 23/62; H04N 23/661

(52) U.S. Cl. CPC H04W 52/0254; H04N 23/62; H04N 23/661; H04W 52/0267

(57) ABSTRACT

An imaging apparatus includes: a wireless communication unit that performs wireless communication with another information processing apparatus using an antenna; and a power control unit that controls power to be supplied to the antenna in accordance with a transmission condition of captured image data in the wireless communication.

### TECHNICAL FIELD

The present technology relates to an imaging apparatus, a power control method, and a program, and particularly relates to a technology regarding an imaging apparatus, a power control method, and a program for controlling power consumption in wireless communication.

### BACKGROUND ART

Wireless communication functions are increasingly mounted on imaging apparatuses. In wireless communication, required power varies depending on communication distances. Therefore, if power to be supplied to an antenna is determined on the assumption of wireless communication in a long distance, power consumption more than necessary is consumed during wireless communication in a short distance.

Patent Document 1 below discloses a technology of reducing power supplied to an antenna by detecting approach of a human body to an imaging apparatus.

### CITATION LIST

### Patent Document

Patent Document 1: Japanese Patent Application Laid-Open No. 2003-209483

### SUMMARY OF THE INVENTION

### Problems to be Solved by the Invention

However, in a configuration disclosed in Patent Document 1, a sensor that detects a human body is necessary, and further, it is not possible to associate approach of a user with a function desired by the user. Therefore, it is not possible to estimate power consumption required for implementing the function desired by the user, and it is difficult to say that the power consumption can be sufficiently reduced.

The present technology has been made to solve the above problem, and an object thereof is to reduce power consumption related to wireless communication.

### Solutions to Problems

An imaging apparatus according to the present technology includes: a wireless communication unit that performs wireless communication with another information processing apparatus using an antenna; and a power control unit that controls power to be supplied to the antenna in accordance with a transmission condition of captured image data in the wireless communication.

Therefore, the power supplied to the antenna is variable.

A power control method of the present technology includes: executing, by an imaging apparatus, processing of performing wireless communication with another information processing apparatus using an antenna, and processing of controlling power to be supplied to the antenna in accordance with a transmission condition of captured image data in the wireless communication.

A program of the present technology causes an imaging apparatus to execute: processing of performing wireless communication with another information processing apparatus using an antenna; and processing of controlling power to be supplied to the antenna in accordance with a transmission condition of captured image data in the wireless communication.

Therefore, the power consumption related to the wireless communication can be reduced.

### BRIEF DESCRIPTION OF DRAWINGS

FIG. 1 is a perspective view of an imaging apparatus of an embodiment of the present technology.

FIG. 2 is a rear view of the imaging apparatus.

FIG. 3 is a functional block diagram of the imaging apparatus.

FIG. 4 is a functional block diagram of a camera control unit.

FIG. 5 is an example of a network function menu screen in which items related to wireless communication are aggregated.

FIG. 6 illustrates an example of a connection mode for transmitting image data from the imaging apparatus to a smartphone.

FIG. 7 is a diagram illustrating an example of a connection mode for uploading image data from the imaging apparatus to an FTP server.

FIG. 8 is a diagram illustrating an example of a connection mode for operating the imaging apparatus by a remote operation using the smartphone.

FIG. 9 is a flowchart illustrating an example of processing executed by a camera control unit in a first embodiment.

FIG. 10 is a flowchart illustrating an example of processing executed by a camera control unit in a second embodiment.

FIG. 11 is a functional block diagram of a camera control unit in a third embodiment.

FIG. 12 is a flowchart illustrating an example of processing executed by the camera control unit in the third embodiment.

### MODE FOR CARRYING OUT THE INVENTION

Hereinafter, embodiments will be described in the following order.
<1. Configuration of Imaging Apparatus>
<2. Functional Configuration of Imaging Apparatus>
<3. Processing Flow>
<4. Second Embodiment>
<5. Third Embodiment>
<6. Conclusion>
<7. Present technology>

### 1. Configuration of Imaging Apparatus

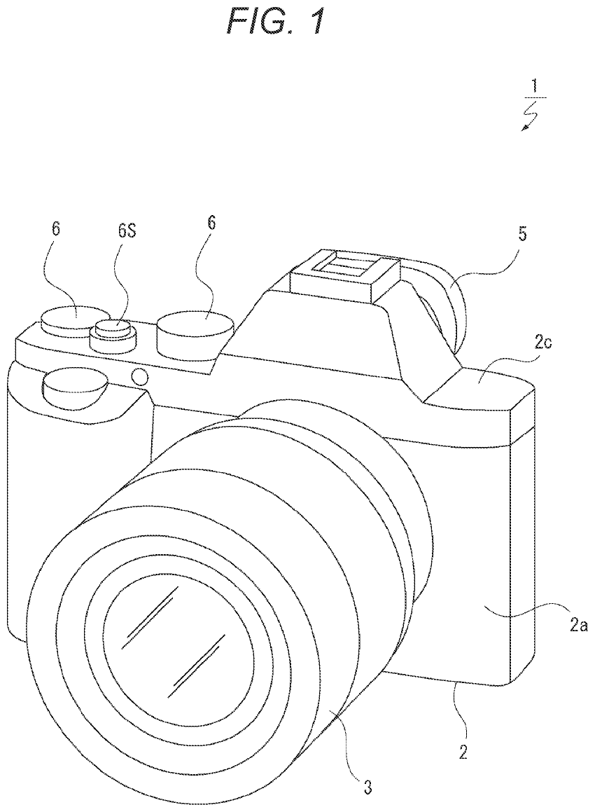

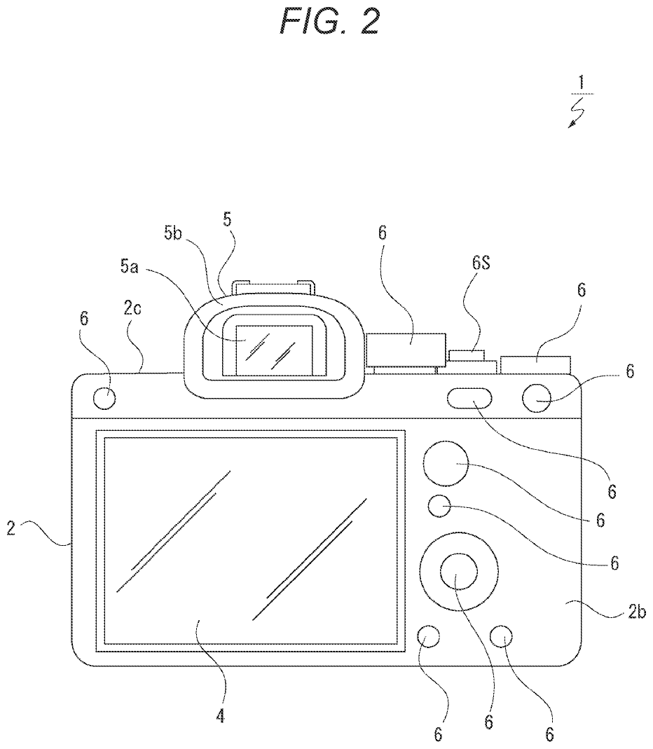

A configuration of an imaging apparatus 1 according to a first embodiment will be described with reference to FIGS. 1 and 2.

Note that, in the following description, data of a still image and data of a moving image will be simply referred to as “image data” when not being distinguished.

The imaging apparatus 1 includes a main body 2 and a lens barrel 3.

In the main body 2, a mount portion (not illustrated) to which the lens barrel 3 is attached is formed on a front surface 2a.

The lens barrel 3 includes optical elements such as a focus lens and a zoom lens inside. Note that the lens barrel 3 illustrated in FIG. 1 is an interchangeable lens barrel, but the lens barrel 3 may be one that is hardly separated from the main body 2.

The main body 2 includes each unit inside and outside.

Specifically, in the main body 2, a backside monitor 4 is provided on a rear surface 2b, an electric viewfinder (EVF) 5 is provided on an upper surface 2c, and various manipulating elements 6 are provided in each unit of the rear surface 2b and the upper surface 2c.

Furthermore, each circuit such as an image sensor, an arithmetic processing unit, and a memory unit (not illustrated), and a power supply circuit that supplies an operating power supply to each unit is provided inside the main body 2.

Note that some of the optical elements may be provided inside the main body 2.

The backside monitor 4 displays a through image, a reproduced image of a recorded image, and the like.

The backside monitor 4 is, for example, a display device such as a liquid crystal display (LCD) or an organic electro-luminescence (EL) display.

The backside monitor 4 is rotatable with respect to the main body 2. For example, an upper end portion of the backside monitor 4 is set as a rotation axis, and a lower end portion of the backside monitor 4 is rotatable so as to move backward. Note that a right end portion or a left end portion of the backside monitor 4 may be used as the rotation axis. Moreover, it may be rotatable in directions around a plurality of axes.

The electric viewfinder 5 includes an EVF monitor 5a and a frame-like enclosing portion 5b projecting backward so as to surround upper, right, and left sides of the EVF monitor 5a.

The EVF monitor 5a is formed with an LCD, an organic EL display, or the like. Note that, instead of the EVF monitor 5a, an optical view finder (OVF) may be provided.

As the manipulating elements 6, for example, a shutter button 6S, a cross key, a determination button, a cancel button, a mode switching button, a zoom-in button, a zoom-out button, and the like are provided. Each of these manipulating elements may be provided not only as a button but also as a dial type, a slide key, a knob, or the like.

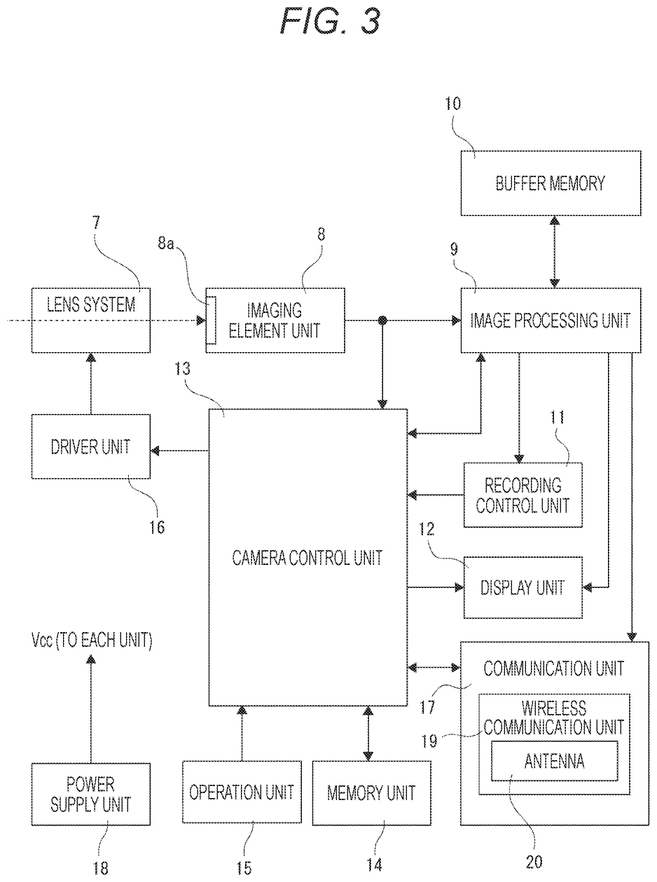

A functional configuration of the imaging apparatus 1 will be described with reference to FIG. 3.

The imaging apparatus 1 includes a lens system 7, an imaging element unit 8, an image processing unit 9, a buffer memory 10, a recording control unit 11, a display unit 12, a camera control unit 13, a memory unit 14, an operation unit 15, a driver unit 16, a communication unit 17, and a power supply unit 18.

The lens system 7 includes various lenses such as an incident end lens, a zoom lens, a focus lens, and a condenser lens, an iris mechanism that performs exposure control by adjusting, for example, an aperture amount of a lens or an iris (diaphragm) such that sensing is performed in a state where signal charges are not saturated and are within a dynamic range, and a shutter unit such as a focal plane shutter.

A part of the lens system 7 may be disposed not only inside the lens barrel 3 but also inside the main body 2.

The imaging element unit 8 includes, for example, an image sensor 8a of a charge coupled device (CCD) type or a complementary metal-oxide semiconductor (CMOS) type.

A sensor surface of the image sensor 8a includes a sensing element in which a plurality of pixels is two-dimensionally arranged. The image sensor 8a performs exposure control for light from a subject, the light being incident through the lens system 7.

The imaging element unit 8 includes a processing unit that performs, for example, correlated double sampling (CDS) processing, automatic gain control (AGC) processing, or analog/digital (A/D) conversion processing on an electric signal obtained by photoelectric conversion by each pixel. Therefore, the imaging element unit 8 outputs a captured image signal as digital data to the image processing unit 9 and the camera control unit 13.

The image processing unit 9 is configured as an image processing processor by, for example, a digital signal processor (DSP) or the like.

The image processing unit 9 performs various types of signal processing on the digital signal (captured image signal), that is, RAW image data, output from the imaging element unit 8.

For example, the image processing unit 9 performs lens correction, noise reduction, synchronization processing, YC generation processing, color reproduction/sharpness processing, and the like.

In the synchronization processing, color separation processing is performed such that image data for each pixel has all red (R), green (G), and blue (B) color components. For example, in the case of an imaging element using a Bayer array color filter, demosaic processing is performed as the color separation processing.

In the YC generation processing, a luminance (Y) signal and a color (C) signal are generated (separated) from image data of R, G, and B.

In the color reproduction/sharpness processing, processing of adjusting gradation, saturation, tone, contrast, and the like as so-called image creation is performed.

The image processing unit 9 performs the above-described signal processing generally called development processing to generate image data in a predetermined format.

In this case, resolution conversion or file formation processing may be performed. In the file formation processing, image data is subjected to, for example, compression encoding for recording or communication, formatting, and generation or addition of metadata to generate a file for recording or communication.

For example, an image file in a format such as Joint Photographic Experts Group (JPEG), Tagged Image File Format (TIFF), Graphics Interchange Format (GIF), or High Efficiency Image File Format (HEIF), is generated as a still image file. Furthermore, it is also conceivable to generate an image file as an MP4 format or the like used for recording a moving image and audio conforming to MPEG-4.

Note that the image processing unit 9 may generate an image file of RAW image data not subjected to the development processing.

The buffer memory 10 is formed using a dynamic random access memory (D-RAM), for example. The buffer memory 10 is used for temporary storage of image data in the course of the development processing and the like described above performed by the image processing unit 9.

Note that the buffer memory 10 may be a memory chip separate from the image processing unit 9, or may be configured as an internal memory area such as a DSP forming the image processing unit 9.

The recording control unit 11 performs recording and reproduction on a recording medium configured using a nonvolatile memory, for example. The recording control unit 11 performs processing of recording an image file such as moving image data or still image data on a recording medium, for example.

Actual forms of the recording control unit 11 can be diversely considered. For example, the recording control unit 11 may include a flash memory built in the imaging apparatus 1 and a write circuit or a read circuit thereof. Furthermore, the recording control unit 11 may be in a form of a card recording/reproducing unit that performs recording/reproducing access to a recording medium detachable from the imaging apparatus 1, for example, a memory card (portable flash memory or the like). Furthermore, the recording control unit 11 may be implemented as a hard disk drive (HDD) or the like as a form built in the imaging apparatus 1.

The display unit 12 is a display unit that performs various displays for a user, and is used as, for example, the backside monitor 4 or the EVF monitor 5a described above.

The display unit 12 executes various displays on a display screen on the basis of an instruction from the camera control unit 13. For example, the display unit 12 displays a reproduced image of image data read from the recording medium in the recording control unit 11.

Furthermore, there is a case where image data of a captured image (captured image data) whose resolution has been converted for a display by the image processing unit 9 is supplied to the display unit 12, and the display unit 12 performs the display on the basis of the image data of the captured image in response to an instruction from the camera control unit 13. Therefore, a so-called through image (subject monitoring image), which is a captured image during composition confirmation or during moving image recording, is displayed.

Furthermore, the display unit 12 executes displays of various operation menus, icons, messages, and the like, that is, graphical user interfaces (GUIs) on the screen on the basis of an instruction from the camera control unit 13.

The camera control unit 13 is configured using a microcomputer including a central processing unit (CPU).

The memory unit 14 stores data and the like used for processing by the camera control unit 13. As the illustrated memory unit 14, for example, a read only memory (ROM), a random access memory (RAM), a flash memory, and the like are comprehensively illustrated.

The memory unit 14 may be a memory area built in a microcomputer chip serving as the camera control unit 13 or may be configured using a separate memory chip.

The camera control unit 13 controls the entire imaging apparatus 1 by executing a program stored in the ROM or the flash memory of the memory unit 14 or the like.

For example, the camera control unit 13 controls operations of the respective units necessary for control of a shutter speed of the imaging element unit 8, instructions of the various types of signal processing in the image processing unit 9, an imaging operation or an image recording operation in accordance with an operation of the user, a reproduction operation of a recorded image file, and control of the zoom lens, the focus lens, and the iris mechanism as the lens system 7. Furthermore, the camera control unit 13 performs processing of sensing operation information by the operation unit 15 as a user interface operation and display control of each display unit such as the backside monitor 4 and the EVF monitor 5a. Furthermore, the camera control unit 13 also performs control related to a communication operation with an external device by the communication unit 17.

The RAM in the memory unit 14 is used for temporary storage of data, a program, and the like as a work area during various types of data processing of the CPU of the camera control unit 13.

The ROM and the flash memory (nonvolatile memory) in the memory unit 14 are used to store an operating system (OS) for the CPU to control the respective units and a content file such as an image file. Furthermore, the ROM and the flash memory in the memory unit 14 are used to store application programs for various operations of the camera control unit 13 and the image processing unit 9, firmware, various types of setting information, and the like.

The operation unit 15 includes a manipulating element 6 provided at each place of the main body 2, the backside monitor 4 equipped with a touch panel function, and the like.

The driver unit 16 includes a motor driver for a zoom lens drive motor, a motor driver for a focus lens drive motor, a motor driver for an iris mechanism motor, and the like, for example.

In these motor drivers, a drive current is applied to the corresponding driver in response to an instruction from the camera control unit 13 to perform moving the focus lens and zoom lens, opening and closing diaphragm blades of the iris mechanism, and the like.

The communication unit 17 includes a wireless communication unit 19 that performs wireless communication. Note that the communication unit 17 may have a function related to wired communication.

The wireless communication unit 19 includes an antenna 20 and a circuit (not illustrated), and can transmit transmission data by supplying necessary operating power to the antenna 20. Furthermore, the antenna 20 can receive reception data in the wireless communication.

Note that the camera control unit 13 has a configuration that varies the power to be supplied to the antenna 20 on the basis of transmission conditions by processing to be described later. The camera control unit 13 according to the present embodiment can supply two types of power, first power P1 and second power P2, to the antenna 20. Furthermore, the second power P2 is power lower than the first power P1, and is selected in a case where it suffices that transmission power in transmission processing in the wireless communication is lower than a predetermined value.

The power supply unit 18 generates a power supply voltage (Vcc) necessary for the respective units from, for example, a battery stored inside the main body 2, and supplies the power supply voltage as an operating voltage.

In a state where the lens barrel 3 is attached to the imaging apparatus 1, the power supply voltage Vcc by the power supply unit 18 is also supplied to a circuit inside the lens barrel 3.

Note that the power supply unit 18 may be formed with a circuit that charges the battery or a circuit that generates the power supply voltage Vcc using a DC voltage converted and input by an AC adapter connected to a commercial AC power supply as a power supply.

The power supply unit 18 in the present embodiment supplies a voltage related to the first power P1 or the second power P2 to the antenna 20 on the basis of the control of the camera control unit 13.

### 2. Functional Configuration of Imaging Apparatus

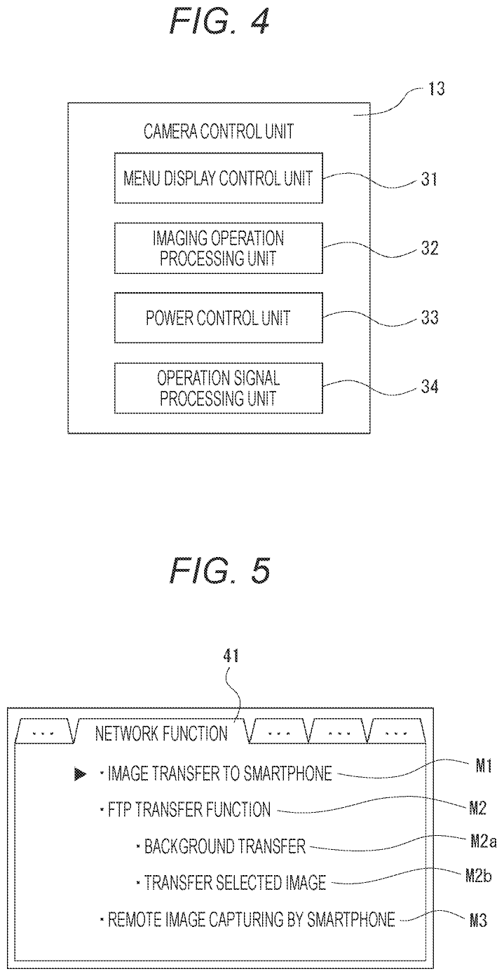

Each function implemented as the camera control unit 13 of the imaging apparatus 1 executes a predetermined program will be described with reference to FIG. 4.

The camera control unit 13 includes a menu display control unit 31, an imaging operation processing unit 32, a power control unit 33, and an operation signal processing unit 34.

The menu display control unit 31 displays various menus on the backside monitor 4. In the present embodiment, the menu display control unit 31 displays a menu screen, which includes a plurality of menu items that requires wireless communication, on the backside monitor 4.

The plurality of menu items that requires wireless communication requires a transmission condition different for each of the items, and requires different power that needs to be supplied to the antenna 20. The transmission condition referred to herein is, for example, a transmission distance.

FIG. 5 illustrates an example of the menu screen displayed on the backside monitor 4.

A plurality of types of the menu screens is provided for each category, for example, and the menu screen illustrated in FIG. 5 is a network function menu screen 41 in which items related to wireless communication are aggregated.

The network function menu screen 41 further includes a plurality of items, and includes, for example, a file transfer menu M1 for transferring various types of captured image data to an external device such as a smartphone or a tablet terminal, a file transfer protocol (FTP) transfer menu M2 for transferring a file to an FTP server using an FTP, and a remote control menu M3 for performing imaging control of the imaging apparatus 1 using an external device such as a smartphone.

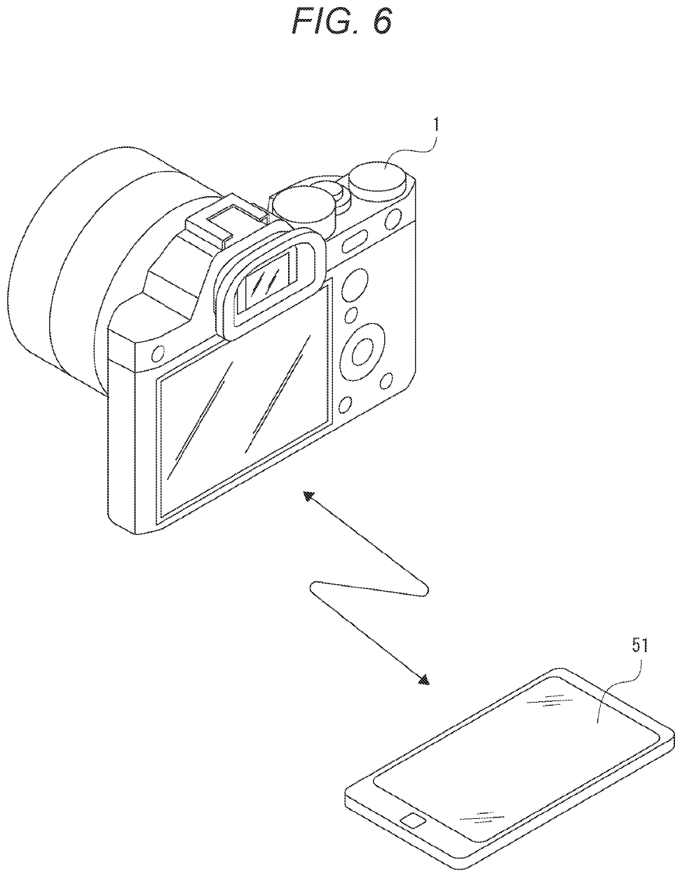

The user can activate a desired function by operating the manipulating element 6 such as the cross key or the determination button provided on the right side of the backside monitor 4 in a state where the network function menu screen 41 is displayed on the backside monitor 4. Note that the user may perform menu selection of a network function by performing an operation on the manipulating element 6 of the imaging apparatus 1, or may perform menu selection of the network function of the imaging apparatus 1 remotely by performing an operation on a manipulating element of an external device wirelessly connected to the imaging apparatus 1 (for example, a touch panel of a smartphone 51 in FIG. 6).

Furthermore, the FTP transfer menu M2 further includes a background transfer menu M2a and a selected image transfer menu M2b.

The background transfer menu M2a is a menu for automatically transmitting image data to the FTP server each time an image is captured.

The selected image transfer menu M2b is a menu for transmitting one or a plurality of pieces of image data selected by the user to the FTP server.

An example of a connection mode between the imaging apparatus 1 and another information processing apparatus, which is a transmission destination of image data, assumed in a case where each menu illustrated in FIG. 5 is selected will be described.

In a case where the file transfer menu M1 is selected, a connection mode as illustrated in FIG. 6 is conceivable. It is assumed that the smartphone 51, which is another information processing apparatus as a transmission destination of image data, is located at a short distance with respect to the imaging apparatus 1. That is, the connection mode illustrated in FIG. 6 is a transmission condition in which power required for transmitting image data is lower than the predetermined value.

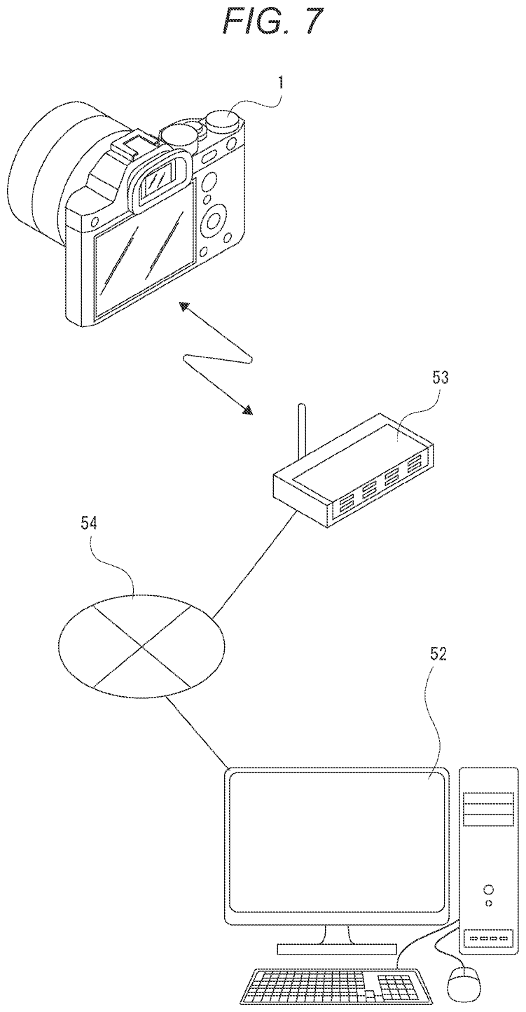

In a case where the background transfer menu M2a or the selected image transfer menu M2b in the FTP transfer menu M2 is selected, a connection mode as illustrated in FIG. 7 is conceivable.

The imaging apparatus 1 and the FTP server 52, which is an information processing apparatus as a final upload destination of image data, are connected via an access point 53 and a communication network 54.

At this time, an information processing apparatus as a direct transmission destination to which image data is transmitted from the imaging apparatus 1 by wireless communication is the access point 53. A distance between the imaging apparatus 1 and the access point 53 is longer than that in the mode illustrated in FIG. 6. That is, the connection mode illustrated in FIG. 7 is a transmission condition in which power required for transmitting image data is not lower than the predetermined value.

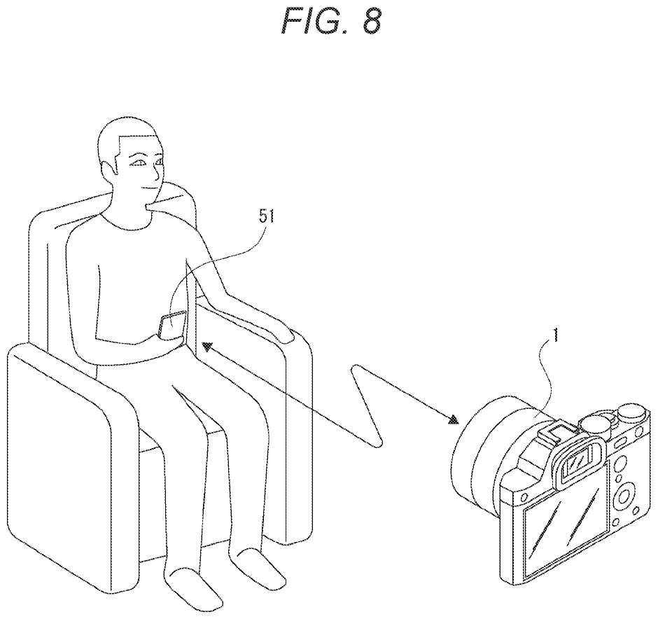

In a case where the remote control menu M3 is selected, a connection mode as illustrated in FIG. 8 is conceivable. It is conceivable that the imaging apparatus 1 and the smartphone 51, which is another information processing apparatus as a transmission destination of image data (for example, a through image), are separated to such an extent that it is difficult to press the shutter button 6S. Furthermore, it is also assumed that the smartphone 51 is farther away than the access point 53 described above depending on an image capturing situation. That is, the connection mode illustrated in FIG. 8 is a transmission condition in which required power is not lower than the predetermined value.

The description returns to FIG. 4.

The imaging operation processing unit 32 performs various types of processing for obtaining image data by using pressing of the shutter button 6S, pressing of the manipulating element 6 as a recording button, or the like performed by the user as a trigger. Specifically, the imaging operation processing unit 32 performs focus control for focusing on a predetermined subject, exposure control for the image sensor 8a, and control related to image processing in the subsequent stage. Furthermore, the imaging operation processing unit 32 also executes timing control or the like for appropriately performing these various types of control.

The power control unit 33 performs control for supplying the first power P1 or the second power P2 to the antenna 20 in accordance with an operation of the user. A specific processing procedure and the like will be described later.

The operation signal processing unit 34 receives an operation signal output from each of the manipulating elements 6 in a case where an operation on the manipulating element 6 as a menu operation or an imaging operation is performed by the user, and performs processing for each operation.

For example, the operation signal processing unit 34 performs processing of causing the menu display control unit 31 to change a menu screen to be displayed on the backside monitor 4 in response to the menu operation by the user, processing of causing the imaging operation processing unit 32 to start the exposure control in response to the imaging operation by the user, and the like. Note that the operation signal processing unit 34 can receive an operation signal based on an operation of the user on the backside monitor 4 having a touch panel function.

### 3. Processing Flow

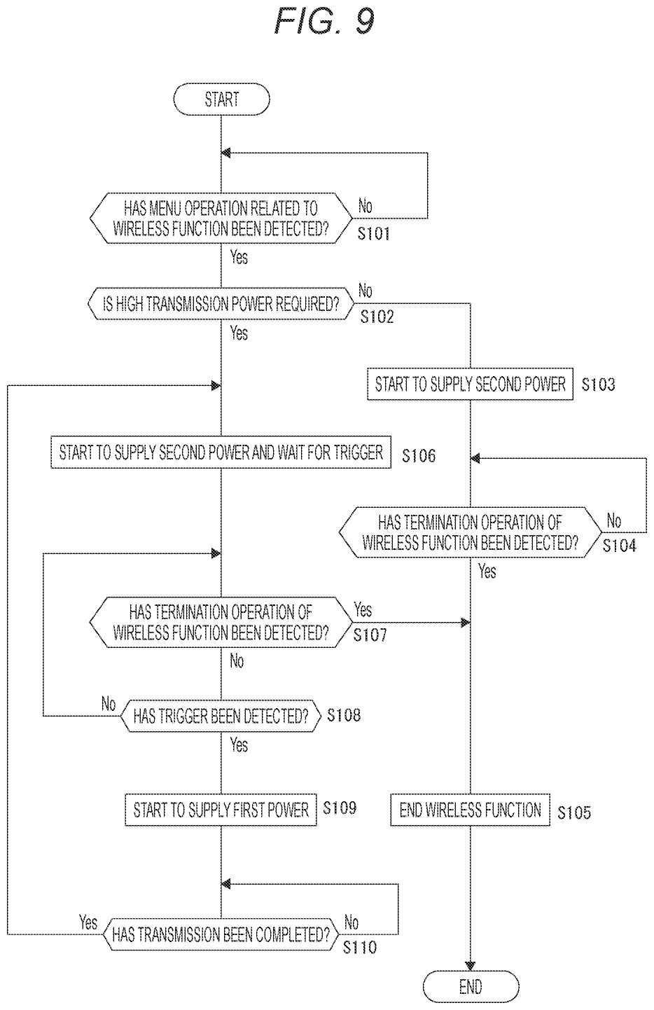

FIG. 9 illustrates a specific flow of each processing executed by the camera control unit 13.

In step S101, the camera control unit 13 determines whether or not a menu operation related to a wireless function has been detected. The menu operation related to the wireless function is, for example, an operation of selecting any menu on the network function menu screen 41 illustrated in FIG. 5.

In a case where the operation has been detected, the camera control unit 13 determines in step S102 whether or not high transmission power equal to or higher than the predetermined value is required. A result of the determination varies depending on a menu selected on the network function menu screen 41.

For example, in a case where the file transfer menu M1 is selected, it is estimated that the smartphone 51 in the connection mode illustrated in FIG. 6 is located at a position of about several tens of cm to several meters with respect to the imaging apparatus 1.

In such a case, it is determined in step S102 that high transmission power equal to or higher than the predetermined value is not required.

Furthermore, in a case where the background transfer menu M2a or the selected image transfer menu M2b of the FTP transfer menu M2, or the remote control menu M3 is selected, it is estimated that the access point 53 or the smartphone 51 as another information processing apparatus that is the transmission destination of image data is far away from the imaging apparatus 1 by higher than several tens of cm or several meters.

In such a case, it is determined in step S102 that high transmission power equal to or higher than the predetermined value is required.

In a case where it is determined in step S102 that high transmission power equal to or higher than the predetermined value is not required, the camera control unit 13 determines whether or not a termination operation of the wireless function has been detected in step S104 after supply of the second power P2 is started in step S103.

For example, in a case where a menu that does not require wireless communication is selected as a menu operation, it is determined that the termination operation of the wireless function has been detected. Specifically, there are a case where a setting is changed such that captured image data is not to be transferred to another information processing apparatus, a case where a setting is changed such that wireless connection is disconnected, and the like.

In a case where it is determined that the termination operation of the wireless function has been detected, the camera control unit 13 ends the wireless function in step S105. Therefore, the supply of power to the antenna 20 of the wireless communication unit 19 ends.

On the other hand, in a case where the termination operation of the wireless function is not detected, the camera control unit 13 performs the processing of step S104 again.

Note that the wireless function may be ended without determining whether or not the termination operation by the user has been detected in step S104. For example, the wireless function may be ended in step S105 in a case where the camera control unit 13 detects that a predetermined number of times of imaging has been performed and a predetermined number of pieces of image data has been transmitted (the number of times of imaging is equal to the number of pieces of transmitted image data).

Furthermore, in a case where it is detected that another menu for using the wireless function is selected instead of the termination operation of the wireless function in step S104, the camera control unit 13 may return to the processing of step S102 again. Therefore, it is possible to supply appropriate power in accordance with the newly selected menu.

Furthermore, in a case where it is determined in step S102 that high transmission power equal to or higher than the predetermined value is required, the camera control unit 13 first starts to supply the second power P2 and waits for a trigger in step S106.

The trigger is a trigger that actually initiates transmission of image data. In a case where the user selects image data to be transmitted from among various types of image data stored in the imaging apparatus 1 and transfers the selected image data to the smartphone 51, pressing of a transmission button performed after selecting the image data serves as the trigger.

Furthermore, in a case where image data obtained by imaging is transmitted to the smartphone 51 every time the imaging is performed, pressing of the shutter button 6S serves as the trigger.

Furthermore, in a mode in which a shutter is automatically turned off by detecting a specific state of a subject to be imaged (for example, detecting a smile of the subject) and in a case where image data obtained by the imaging is transmitted to the smartphone 51, processing of automatically turning off the shutter becomes the trigger.

Note that, if the imaging apparatus 1 is remotely operated, in a case where the user operates the smartphone 51 or the like paired with the imaging apparatus 1, an operation command corresponding to the operation is transmitted from the smartphone 51 to the imaging apparatus 1. Therefore, reception of the operation command by the imaging apparatus 1 can also be the trigger. For example, reception of an operation command corresponding to an operation on an operation icon displayed on a screen of the smartphone 51 can be the trigger. That is, reception of an operation command corresponding to an operation on the shutter button 6S′ displayed as an icon image on the screen of the smartphone 51 may be used as the trigger.

The camera control unit 13 determines whether or not the termination operation of the wireless function has been detected in step S107 in the state of waiting for the trigger. This processing is processing similar to the previous processing in step S104.

In a case where the termination operation of the wireless function has been detected, the camera control unit 13 ends the wireless function in step S105, and ends the series of processing illustrated in FIG. 9.

On the other hand, in a case where the termination operation of the wireless function has not been detected, the camera control unit 13 determines whether or not the trigger has been detected in step S108.

In a case where it is determined that the trigger has not been detected, the camera control unit 13 returns to the processing of step S107. That is, in a case where the termination operation of the wireless function is not performed and the trigger cannot be detected, each determination processing in step S107 and step S108 is repeatedly executed.

In a case where it is determined that the trigger has been detected, the camera control unit 13 starts to supply the first power P1 in step S109, and then, monitors whether or not transmission of image data is completed in step S110. Then, in a case where it is determined in step S110 that the transmission of the image data has not been completed, the camera control unit 13 executes the determination processing in step S110 again.

That is, the first power P1 is supplied to the antenna 20 until the transmission of the image data is completed.

In other words, in a case where the background transfer menu M2a, the selected image transfer menu M2b, or the remote control menu M3 is selected and the trigger is detected, the power control unit 33 determines that a first condition is satisfied and starts to supply the first power P1.

Note that trigger detection in a case where the remote control menu M3 is selected may be performed in a case where an operation of selecting the menu is performed, and an operation of closing the menu may be detected and used as trigger detection in a case where transfer of a through image is started after the menu screen is closed after the selection of the menu.

Note that the completion of transmission of the image data may be detected by completion of transmission processing of the image data to be transmitted, or may be detected by reception of an acknowledgement (Ack) from a communication target device.

In a case where it is determined in step S110 that the transmission of the image data has been completed, the camera control unit 13 returns to step S106 and waits for a trigger while starting to supply the second power P2 to the antenna 20 again.

As the camera control unit 13 executes the series of processing illustrated in FIG. 9, the second power P2 lower than the first power P1 is supplied to the antenna 20 until transmission of image data is performed in the imaging apparatus 1, whereby power consumption is reduced.

Furthermore, the first power P1 is supplied to the antenna 20 during the transmission of image data requiring high power equal to or higher than the predetermined value, so that necessary transmission processing can be implemented.

Note that the camera control unit 13 may return to the processing of step S102 in a case where an operation of changing a menu related to the wireless function is detected in the middle of each processing in FIG. 9 (after step S101 and before the wireless function ends in step S105). Therefore, it is possible to share appropriate power in accordance with the newly selected menu.

### 4. Second Embodiment

The imaging apparatus 1 in a second embodiment can supply not only the first power P1 and the second power P2 but also third power P3 to the antenna 20.

The third power P3 is, for example, higher than the first power P1. That is, “third power P3>first power P1>second power P2” is established in descending order of power.

The camera control unit 13 supplies the first power P1 to the antenna 20 in a case where a first condition is satisfied, supplies the second power P2 to the antenna 20 in a case where a second condition is satisfied, and supplies the third power P3 to the antenna 20 in a case where a third condition is satisfied.

For example, in a case where the file transfer menu M1 is selected on the network function menu screen 41 illustrated in FIG. 5, the power control unit 33 estimates that a communication distance is several tens of cm at most, and supplies the antenna 20 with the second power P2 which is the lowest among the above-described suppliable power values.

Furthermore, in a case where the background transfer menu M2a or the selected image transfer menu M2b in the FTP transfer menu M2 is selected, the power control unit 33 estimates that a communication distance is several tens of cm to several meters, and supplies the antenna 20 with the first power P1 which is medium among the above-described suppliable power values.

For example, in a case where the background transfer menu M2a or the selected image transfer menu M2b is selected and it is detected that a transmission timing of image data has arrived, the power control unit 33 determines that the first condition is satisfied and starts to supply the first power P1.

On the other hand, in a case where the remote control menu M3 is selected, the power control unit 33 estimates that a communication distance is likely to be several tens of meters, and supplies the antenna 20 with the third power P3 which is the highest among the above-described suppliable power values.

That is, in a case where the remote control menu M3 is selected and it is detected that the transmission timing of the image data has arrived, the power control unit 33 determines that the third condition is satisfied and starts to supply the third power P3.

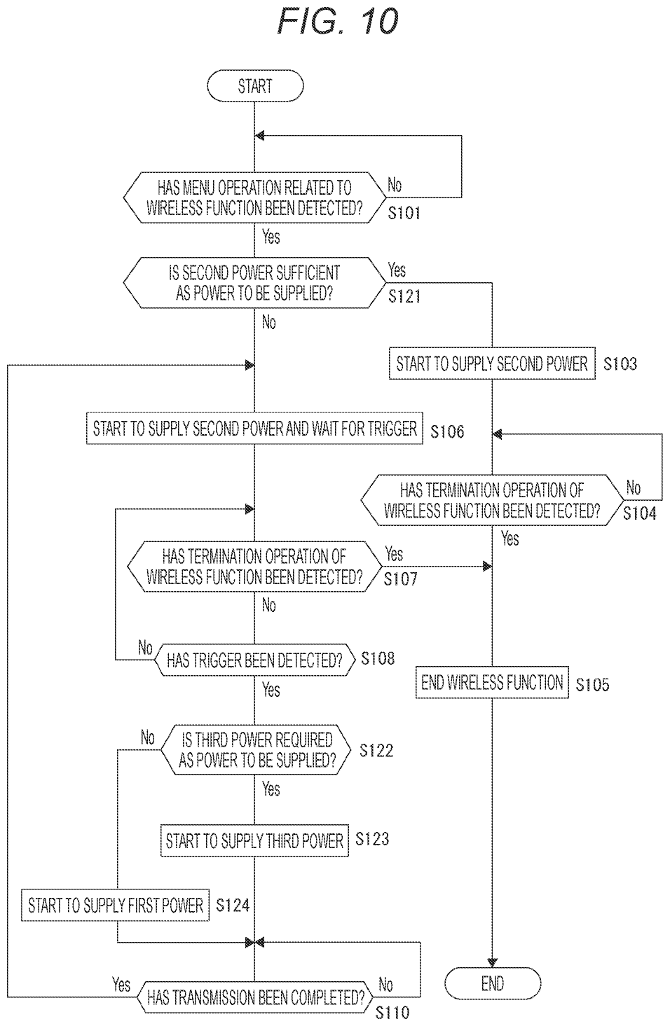

A flow of processing executed by the camera control unit 13 in the second embodiment in order to supply power to the antenna 20 will be described with reference to FIG. 10.

Note that processing similar to that in FIG. 9 will be denoted by the same step number, and description thereof will be omitted as appropriate.

In step S101, the camera control unit 13 determines whether or not a menu operation related to a wireless function has been detected. The processing of step S101 is repeatedly executed until the menu operation related to the wireless function is detected.

In a case where the operation is detected, the camera control unit 13 determines in step S121 whether or not the second power P2 is sufficient as power to be supplied. This determination processing is performed on the basis of a menu item selected by a user as described above.

In a case where it is determined that the supply of the second power P2 is sufficient as in a case where the file transfer menu M1 is selected, the camera control unit 13 performs each processing in steps S103, S104, and S105 and continues to supply the second power P2 to the antenna 20 until a termination operation of the wireless function is detected.

On the other hand, in a case where it is determined that the supply of the second power P2 is not sufficient as in a case where the FTP transfer menu M2 or the remote control menu M3 is selected, the camera control unit 13 first starts to supply the second power P2 and waits for a trigger in step S106.

The camera control unit 13 determines whether or not the termination operation of the wireless function has been detected in step S107, and proceeds to step S105 to end the wireless function in a case where the operation has been detected.

In a case where the operation has not been detected, the camera control unit 13 determines in step S108 whether or not a trigger for transmission of image data has been detected. In a case where the trigger has not been detected, the camera control unit 13 executes each processing in step S107 and step S108 again.

In a case where it is determined that the trigger for transmission of image data has been detected, the camera control unit 13 determines in step S122 whether or not the third power P3 is required as power to be supplied to the antenna 20.

In a case where it is determined that the third power P3 is required as in a case where the remote control menu M3 is selected, the camera control unit 13 starts to supply the third power in step S123 and determines whether or not the transmission of the image data has been completed in step S110.

On the other hand, in a case where it is determined that the supply of the third power P3 is not required as in a case where the background transfer menu M2a or the selected image transfer menu M2b is selected, the camera control unit 13 starts to supply the first power P1 in step S124 and determines whether or not the transmission of the image data has been completed in step S110.

By executing the series of processing illustrated in FIG. 10, appropriate power among the first power P1, the second power P2, and the third power P3 is selected and supplied to the antenna 20 in the processing of transmitting image data. Therefore, it is possible to appropriately transmit image data while suppressing waste of power consumption.

Note that it is determined whether or not the third power P3 is required as the power to be supplied to the antenna 20 to start supply of either the first power P1 or the third power P3 in accordance with the determination result in step S122 after the trigger detection in step S108 in the processing illustrated in FIG. 10, but the present embodiment is not limited thereto. That is, a power value corresponding to a menu related to the wireless function selected in step S101 may be stored in a storage unit such as the memory unit 14, and the stored power value may be supplied to the antenna 20 after the trigger detection in step S108.

### 5. Third Embodiment

An imaging apparatus 1A according to a third embodiment determines power to be supplied to the antenna 20 in accordance with reception strength at the time of receiving data from another information processing apparatus (hereinafter, described as “transmission target equipment”) which is a transmission destination of image data.

For example, the imaging apparatus 1A may receive an acknowledgement or the like from the smartphone 51 or the access point 53 which is the transmission target equipment. A distance to the smartphone 51 or the access point 53 is estimated on the basis of the reception strength at that time, and appropriate power is supplied to the antenna 20.

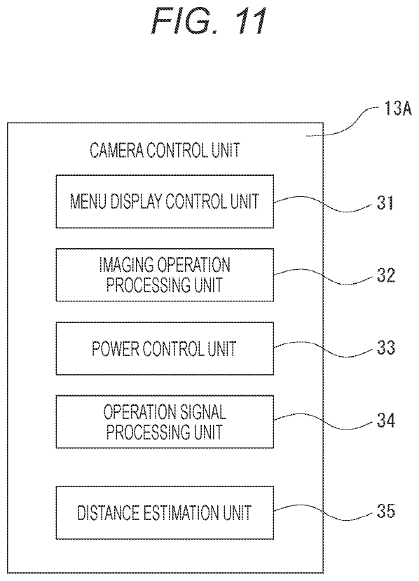

As illustrated in FIG. 11, in the imaging apparatus 1A, a camera control unit 13A includes the menu display control unit 31, the imaging operation processing unit 32, the power control unit 33, the operation signal processing unit 34, and a distance estimation unit 35.

Since the menu display control unit 31, the imaging operation processing unit 32, the power control unit 33, and the operation signal processing unit 34 are similar to the above-described configurations, detailed description thereof will be omitted.

The distance estimation unit 35 performs processing of estimating a distance of transmission target equipment such as the smartphone 51 or the access point 53, which is a transmission destination of image data, from the imaging apparatus 1A.

Here, an example of estimating the distance to the transmission target equipment from the reception strength such as an acknowledgement received from the transmission target equipment will be described, but other methods may be used.

For example, in a case where each equipment is capable of acquiring position information using an ultra wide band (UWB), the imaging apparatus 1 may acquire position information regarding the transmission target equipment to estimate distance information with respect to the transmission target equipment.

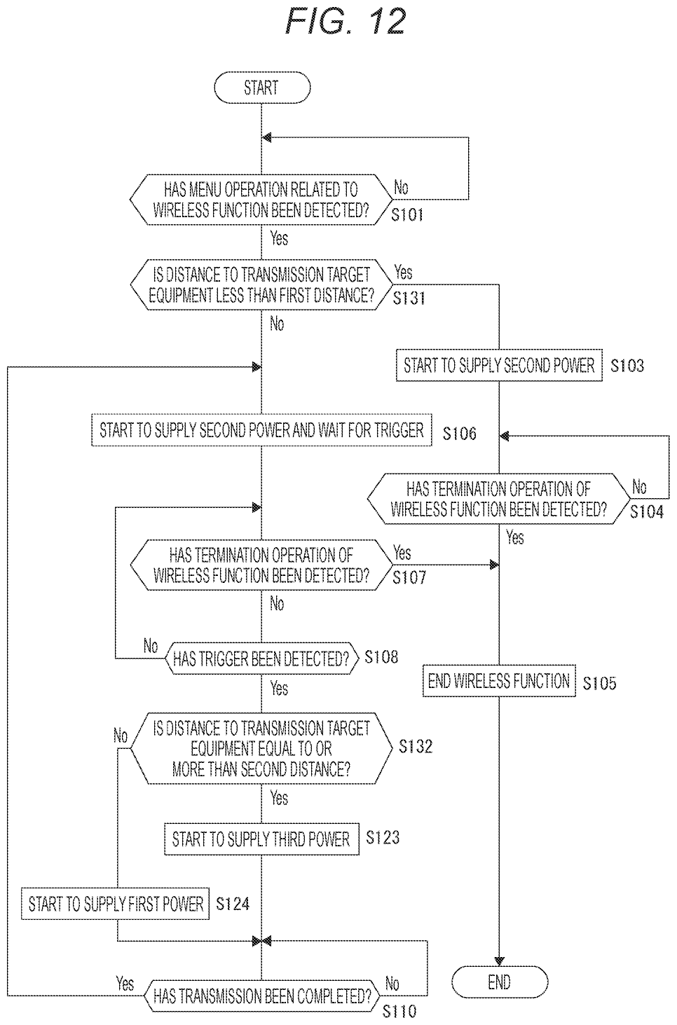

A flow of processing executed by the camera control unit 13A in the third embodiment in order to supply power to the antenna 20 will be described with reference to FIG. 12.

Note that processing similar to those in FIGS. 9 and 10 will be denoted by the same step number, and description thereof will be omitted as appropriate.

In step S101, the camera control unit 13A determines whether or not a menu operation related to a wireless function has been detected. The processing of step S101 is repeatedly executed until the menu operation related to the wireless function is detected.

In a case where the operation has been detected, the camera control unit 13A determines in step S131 whether or not a distance to transmission target equipment (the smartphone 51, the access point 53, or the like) is less than a first distance. The first distance is a distance from the imaging apparatus 1A to the transmission target equipment at which transmission of image data can be normally completed in a case where the second power P2 is supplied to the antenna 20.

As described above, this determination processing is performed on the basis of the distance estimated by the distance estimation unit 35 for the transmission target equipment and the imaging apparatus 1A.

In a case where it is estimated that the distance from the imaging apparatus 1A to the transmission target equipment is less than the first distance, the camera control unit 13A performs each processing in steps S103, S104, and S105, and continues to supply the second power P2 to the antenna 20 until a termination operation of the wireless function is detected.

On the other hand, in a case where it is determined that the distance from the imaging apparatus 1A to the transmission target equipment is equal to or more than the first distance, the camera control unit 13A first starts to supply the second power P2 and waits for a trigger in step S106.

The camera control unit 13A determines whether or not the termination operation of the wireless function has been detected in step S107, and proceeds to step S105 to end the wireless function in a case where the operation has been detected.

In a case where the termination operation of the wireless function has not been detected in step S107, the camera control unit 13A determines in step S108 whether or not a trigger for transmission of image data has been detected. In a case where the trigger has not been detected, the camera control unit 13A executes each processing in step S107 and step S108 again.

In a case where it is determined in step S108 that the trigger for transmission of image data has been detected, the camera control unit 13A determines in step S132 whether or not the distance from the imaging apparatus 1A to the transmission target equipment is equal to or more than a second distance. The second distance is a distance longer than the first distance, and is a distance from the imaging apparatus 1A to the transmission target equipment at which transmission of image data can be normally completed in a case where the first power P1 is supplied to the antenna 20.

As described above, this determination processing is performed on the basis of the distance estimated by the distance estimation unit 35 for the transmission target equipment and the imaging apparatus 1A.

In a case where it is determined in step S132 that the distance from the imaging apparatus 1A to the transmission target equipment is equal to or more than the second distance, the camera control unit 13A starts to supply the third power in step S123, and then, determines whether or not the transmission of the image data has been completed in step S110.

On the other hand, in a case where it is determined in step S132 that the distance from the imaging apparatus 1A to the transmission target equipment is less than the second distance, that is, in a case where it is determined that the distance from the imaging apparatus 1A to the transmission target equipment estimated by the distance estimation unit 35 is equal to or more than the first distance and less than the second distance, the camera control unit 13A starts to supply the first power P1 in step S124, and then, determines whether or not the transmission of the image data has been completed in step S110.

By executing the series of processing illustrated in FIG. 12, appropriate power among the first power P1, the second power P2, and the third power P3 is selected and supplied to the antenna 20 in the transmission processing of the image data in accordance with the distance between the imaging apparatus 1A and the transmission target equipment. Therefore, it is possible to appropriately transmit image data while suppressing waste of power consumption.

Note that the distance between the imaging apparatus 1A and the transmission target equipment is estimated to determine the power to be supplied to the antenna 20 in the third embodiment, but each determination processing may be performed by comparing reception strength of reception data received from the transmission target equipment with a threshold. For example, the second power P2 in a case where the strength of the reception data received from the transmission target equipment is less than a first threshold, the first power P1 in a case where the strength of the reception data is equal to or more than the first threshold and less than a second threshold, and the third power P3 in a case where the strength of the reception data is equal to or more than the second threshold may be supplied to the antenna 20 at the time of transmitting image data. This eliminates the need to perform processing of converting the reception strength into the distance. Furthermore, appropriate power can be supplied to the antenna 20 even in a case where a communication environment is poor and the reception strength with respect to the distance is lower than an estimation.

Furthermore, a conversion formula for calculating power to be supplied to the antenna 20 from reception strength of reception data may be used. That is, the power supplied to the antenna 20 may continuously change with respect to a change in the reception strength.

Therefore, appropriate power can be supplied to the antenna 20 even in a situation where a communication environment changes from moment to moment, and thus, transmission of image data can be performed without any problem while suppressing power consumption.

### 6. Summary

As described in each of the examples described above, the imaging apparatus 1 (1A) includes: the wireless communication unit 19 that performs wireless communication with another information processing apparatus (the smartphone 51, the access point 53, or the like) using the antenna 20; and the power control unit 33 that controls power to be supplied to the antenna 20 in accordance with a transmission condition of image data of a captured image in wireless communication.

Therefore, the power supplied to the antenna 20 is variable.

Examples of the transmission condition include a case where it is determined by a menu item selected by a user and a case where it is determined by a positional relationship between the imaging apparatus 1 and the another information processing apparatus.

Therefore, since appropriate supply power in accordance with the transmission condition can be supplied to the antenna 20, it is possible to reduce power consumption while performing necessary wireless communication.

As described with reference to FIGS. 6, 7, 8, and the like, the transmission condition may be determined in accordance with a user operation related to a setting of the imaging apparatus 1 (1A).

A function of the imaging apparatus 1 desired by the user is determined by the user operation. Therefore, it is possible to supply power to the antenna 20 for appropriately implementing the function desired by the user.

As described with reference to FIG. 5 and the like, the user operation of determining the transmission condition may be an operation of selecting a menu item (each menu on the network function menu screen 41) related to a setting of the transmission of the image data of the captured image by the imaging apparatus 1 (1A) to the another information processing apparatus (the smartphone 51, the access point 53, or the like).

In a case where the transmission condition is different in accordance with a menu item selected by the user, appropriate power can be supplied to the antenna 20 in accordance with the menu item.

As described with reference to FIGS. 6, 7, 8, 9, and the like, the power control unit 33 may supply the first power P1 to the antenna 20 in a case where the transmission condition satisfies a first condition, and may supply the second power P2 lower than the first power P1 to the antenna 20 in a case where the transmission condition satisfies a second condition.

Therefore, it is possible to supply different power in at least two or more stages to the antenna 20. Therefore, it is possible to select appropriate supply power in accordance with the user operation and supply the selected supply power to the antenna 20.

As described with reference to FIG. 7 and the like, the first condition may be satisfied in a case where an operation of selecting a menu item (the background transfer menu M2a and the selected image transfer menu M2b in the FTP transfer menu M2, or the like) for transmitting the image data of the captured image to a server device (for example, the FTP server 52), which is the another information processing apparatus, is performed.

The image data of the captured image is assumed to be transmitted to the server device via, for example, the access point 53 at a distance of several meters to several tens of meters.

In such a case, appropriate wireless communication can be performed, for example, by supplying the first power P1 higher than the second power P2 to the antenna 20.

As described with reference to FIG. 6 and the like, the second condition may be satisfied in a case where an operation of selecting a menu item (the file transfer menu M1) for transmitting the image data of the captured image to a mobile terminal (for example, the smartphone 51), which is the another information processing apparatus (transmission target equipment), is performed.

In a case where the image data of the captured image is transmitted to the mobile terminal, for example, it is assumed that the distance between the imaging apparatus 1 (1A) and the mobile terminal is several tens of cm to several meters.

In such a case, it is possible to reduce power consumption while performing appropriate wireless communication, for example, by supplying the second power P2 lower than the first power P1 to the antenna 20.

Note that the mobile terminal is not limited to the smartphone 51 described above, and may be a tablet terminal, a feature phone, a smart glass, a head-mounted device, or the like.

As described above, the user operation of determining the transmission condition may include an operation performed on the another information processing apparatus (for example, the smartphone 51).

For example, there is a use mode in which the imaging apparatus 1 is remotely operated by linking the imaging apparatus 1 (1A) with another (external) information processing apparatus such as the smartphone 51. Then, it is possible to cause the imaging apparatus 1 to transmit the image data of the captured image by the remote operation from the smartphone 51.

According to the present configuration, the transmission condition is determined in accordance with the operation performed on the another information processing apparatus such as the smartphone 51, and appropriate power can be supplied to the antenna 20. That is, even in the case of the remote operation, it is possible to reduce power consumption related to transmission of image data and a command to the another information processing apparatus while performing appropriate wireless communication.

As described with reference to FIG. 9 and the like, the power control unit 33 may change the power to be supplied to the antenna 20 in accordance with a timing at which an operation of starting transmission of the image data of the captured image to the another information processing apparatus (the smartphone 51, the access point 53, or the like) is performed.

In a case where the transmission condition is determined in accordance with the menu operation, various timings can be considered for changing the power to be supplied to the antenna 20.

For example, in a case where it is set such that a still image is captured at a timing when the shutter button 6S is pressed and data of the captured image is transmitted to a server (the FTP server 52), the power is increased at this transmission timing.

Alternatively, transmission power may be determined and transmission of a through image may be started as the manipulating element 6 for determining to transmit the through image to the smartphone 51 is operated.

In this manner, the power to be supplied to the antenna 20 is optimized at a timing when the operation is actually performed on the manipulating element 6 that starts the transmission of the image data of the captured image. Therefore, it is possible to supply appropriate power to the antenna 20 at a timing when transmission processing is started while suppressing power consumption until immediately before the transmission processing is performed, and it is possible to implement the transmission processing desired by the user.

Furthermore, the operation of starting transmission of the image data of the captured image may be an operation of pressing the shutter button 6S.

An example of the manipulating element 6 for starting the transmission of the image data of the captured image is the shutter button 6S. Although a still image is captured, for example, when the operation using the shutter button 6S is performed, the image data of the captured image may be transmitted to the another information processing apparatus (the smartphone 51 or the access point 53) immediately after capturing the still image depending on a setting.

According to the present configuration, when the shutter button 6S is pressed so that the still image is captured, it is possible to prevent the transmission processing of the image data of the captured image performed immediately thereafter from being disturbed by supplying appropriate power to the antenna 20. Furthermore, it is also possible to reduce power consumption until the shutter button 6S is pressed.

The shutter button 6S as the manipulating element 6 for determining the transmission condition may be a manipulating element for remote operation (the shutter button 6S′) displayed on a display unit of the another information processing apparatus (for example, the smartphone 51).

The shutter button 6S is not necessarily a physical button provided in the imaging apparatus 1 (1A), and may be, for example, the shutter button 6S′ on software displayed as an icon image or the like on a screen of the smartphone 51 or the like, which is the another information processing apparatus for remote operation, as in the present configuration.

Therefore, appropriate power is supplied to the antenna 20 at an appropriate timing even when the remote operation is performed, it is possible to implement the transmission processing without interruption while suppressing power consumption until the shutter button 6S′ is pressed.

As described in the second embodiment, the power control unit 33 may supply the third power P3 higher than the first power P1 to the antenna 20 in a case where the transmission condition satisfies a third condition.

Therefore, it is possible to supply different power in at least three or more stages to the antenna 20. Therefore, since more appropriate supply power can be selected in accordance with a user operation, it is possible to further suppress the power consumption while performing necessary transmission processing.

Furthermore, the power to be supplied to the antenna 20 may be changed simultaneously with a timing of an operation of pressing the shutter button 6S or starting transmission of the image data of the captured image as described above, or the power to be supplied to the antenna 20 may be changed immediately after the timing or after a lapse of a predetermined time.

As described in the second embodiment, the third condition may be satisfied in a case where an operation of selecting a menu item for starting reception of a remote operation from a mobile terminal (such as the smartphone 51), which is the another information processing apparatus, is performed.

In a case where an imaging operation by the imaging apparatus 1 (1A) is implemented by the remote operation from the mobile terminal, a distance between the mobile terminal and the imaging apparatus 1 is several meters to several tens of meters in some cases. Then, it is necessary to display a through image on a display unit of the mobile terminal in order not to miss an appropriate shutter chance using the mobile terminal.

In such a case, appropriate wireless communication for displaying the through image on the display unit of the mobile terminal can be performed, for example, by supplying the third power P3 higher than the first power P1 to the antenna 20.

As described in the third embodiment, the transmission condition may be determined in accordance with reception strength in the wireless communication.

Other transmission conditions for supplying appropriate power to the antenna 20 are conceivable in addition to those described above. For example, reception strength when an acknowledgement is received in the wireless communication may be used. Specifically, a communication distance in the wireless communication may be estimated on the basis of the reception strength to supply appropriate power to the antenna 20.

Therefore, appropriate power in accordance with an actual communication environment can be supplied to the antenna 20, and both the execution of transmission processing and the reduction of power consumption can be achieved.

As described with reference to FIG. 10 and the like, in a case where the transmission condition satisfies the first condition or the third condition, the power control unit 33 may set the power to be supplied to the antenna 20 to the second power P2 before a timing at which an operation of starting transmission of the image data of the captured image to the another information processing apparatus (the smartphone 51, the access point 53, or the like) is performed, and supply the first power P1 or the third power P3 higher than the second power P2 to the antenna 20 after the timing.

The power consumption can be suppressed as much as possible by supplying the lower second power P2 until the supply of the first power P1 or the third power P3 is required.

The program according to the embodiments is, for example, a program for causing a CPU, a DSP, or the like, or a device including these to execute each processing illustrated in FIGS. 9, 10, and 11.

That is, the program of the embodiments causes the camera control unit 13 of the imaging apparatus 1 (1A) to execute processing of performing wireless communication with another information processing apparatus using the antenna.

Furthermore, the camera control unit 13 of the imaging apparatus 1 (1A) is caused to execute processing of controlling the power to be supplied to the antenna 20 in accordance with the transmission condition of the image data of the captured image in the wireless communication.

With such a program, the above-described imaging apparatus 1 (1A) can be achieved.

A program for achieving such an imaging apparatus 1 (1A) can be recorded in advance in an HDD as a recording medium built in equipment such as a computer device, a ROM in a microcomputer having a CPU, or the like.

Alternatively, the program may be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as what is called package software.

Furthermore, such a program may be installed from the removable recording medium into a personal computer or the like, or may be downloaded from a download site via a network such as a local area network (LAN) or the Internet.

Furthermore, such a program is suitable for providing the imaging apparatus 1 of the embodiment in a wide range. For example, by downloading the program to equipment having a camera function such as a mobile terminal device such as a smartphone or a tablet having a camera function, a mobile phone, a personal computer, a game device, a video device, a personal digital assistant (PDA), or the like, the smartphone or the like can be caused to function as the imaging apparatus 1 of the present disclosure.

Note that the effects described in the present specification are merely examples and are not limited, and other effects may be provided.

Furthermore, the above-described respective examples may be combined in any way, and the above-described various functions and effects may be obtained even in a case where various combinations are used.

### 7. Present Technology

(1)

An imaging apparatus including:
a wireless communication unit that performs wireless communication with another information processing apparatus using an antenna; and
a power control unit that controls power to be supplied to the antenna in accordance with a transmission condition of captured image data in the wireless communication.
   (2)

The imaging apparatus according to (1), in which
the transmission condition is determined in accordance with a user operation related to a setting of the imaging apparatus.
   (3)

The imaging apparatus according to (2), in which
the user operation is an operation of selecting a menu item related to a transmission setting of the captured image data to the another information processing apparatus by the imaging apparatus.
   (4)

The imaging apparatus according to any one of (1) to (3), in which
the power control unit supplies first power to the antenna in a case where the transmission condition satisfies a first condition, and supplies second power lower than the first power to the antenna in a case where the transmission condition satisfies a second condition.
   (5)

The imaging apparatus according to (4), in which
the first condition is satisfied in a case where an operation of selecting a menu item for transmitting the captured image data to a server device, which is the another information processing apparatus, is performed.
   (6)

The imaging apparatus according to any one of (4) to (5), in which
the second condition is satisfied in a case where an operation of selecting a menu item for transmitting the captured image data to a mobile terminal, which is the another information processing apparatus, is performed.
   (7)

The imaging apparatus according to any one of (2) to (6), in which
the user operation includes an operation performed on the another information processing apparatus.
   (8)

The imaging apparatus according to any one of (1) to (7), in which
the power control unit changes the power to be supplied to the antenna in accordance with a timing at which an operation of starting transmission of the captured image data to the another information processing apparatus is performed.
   (9)

The imaging apparatus according to (8), in which
the operation of starting transmission of the captured image data is an operation of pressing a shutter button.
   (10)

The imaging apparatus according to (9), in which
the shutter button is a manipulating element for remote operation displayed on a display unit of the another information processing apparatus.
   (11)

The imaging apparatus according to any one of (4) to (6), in which
the power control unit supplies third power higher than the first power to the antenna in a case where the transmission condition satisfies a third condition.
   (12)

The imaging apparatus according to (11), in which
the third condition is satisfied in a case where an operation of selecting a menu item for starting reception of a remote operation from a mobile terminal, which is the another information processing apparatus, is performed.
   (13)

The imaging apparatus according to any one of (1) to (12), in which
the transmission condition is determined in accordance with reception strength in the wireless communication.
   (14)

The imaging apparatus according to any one of (11) to (12), in which
in a case where the transmission condition satisfies the first condition or the third condition, the power control unit sets the power to be supplied to the antenna to the second power before a timing at which an operation of starting transmission of the captured image data to the another information processing apparatus is performed, and supplies the first or third power higher than the second power to the antenna after the timing.
   (15)

A power control method including:
executing, by an imaging apparatus,
processing of performing wireless communication with another information processing apparatus using an antenna, and
processing of controlling power to be supplied to the antenna in accordance with a transmission condition of captured image data in the wireless communication.
   (16)

A program for causing an imaging apparatus to execute:
processing of performing wireless communication with another information processing apparatus using an antenna; and
processing of controlling power to be supplied to the antenna in accordance with a transmission condition of captured image data in the wireless communication.

### REFERENCE SIGNS LIST

1, 1A Imaging apparatus
6 Manipulating element
6S, 6S′ Shutter button
19 Wireless communication unit
20 Antenna
33 Power control unit
P1 First power
P2 Second power
P3 Third power

1. An imaging apparatus comprising:
a wireless communication unit that performs wireless communication with another information processing apparatus using an antenna; and
a power control unit that controls power to be supplied to the antenna in accordance with a transmission condition of captured image data in the wireless communication.

2. The imaging apparatus according to claim 1, wherein
the transmission condition is determined in accordance with a user operation related to a setting of the imaging apparatus.

3. The imaging apparatus according to claim 2, wherein
the user operation is an operation of selecting a menu item related to a transmission setting of the captured image data to the another information processing apparatus by the imaging apparatus.

4. The imaging apparatus according to claim 1, wherein
the power control unit supplies first power to the antenna in a case where the transmission condition satisfies a first condition, and supplies second power lower than the first power to the antenna in a case where the transmission condition satisfies a second condition.

5. The imaging apparatus according to claim 4, wherein
the first condition is satisfied in a case where an operation of selecting a menu item for transmitting the captured image data to a server device, which is the another information processing apparatus, is performed.

6. The imaging apparatus according to claim 4, wherein
the second condition is satisfied in a case where an operation of selecting a menu item for transmitting the captured image data to a mobile terminal, which is the another information processing apparatus, is performed.

7. The imaging apparatus according to claim 2, wherein
the user operation includes an operation performed on the another information processing apparatus.

8. The imaging apparatus according to claim 1, wherein
the power control unit changes the power to be supplied to the antenna in accordance with a timing at which an operation of starting transmission of the captured image data to the another information processing apparatus is performed.

9. The imaging apparatus according to claim 8, wherein the operation of starting transmission of the captured image data is an operation of pressing a shutter button.

10. The imaging apparatus according to claim 9, wherein
the shutter button is a manipulating element for remote operation displayed on a display unit of the another information processing apparatus.

11. The imaging apparatus according to claim 4, wherein
the power control unit supplies third power higher than the first power to the antenna in a case where the transmission condition satisfies a third condition.

12. The imaging apparatus according to claim 11, wherein
the third condition is satisfied in a case where an operation of selecting a menu item for starting reception of a remote operation from a mobile terminal, which is the another information processing apparatus, is performed.

13. The imaging apparatus according to claim 1, wherein
the transmission condition is determined in accordance with reception strength in the wireless communication.

14. The imaging apparatus according to claim 11, wherein
in a case where the transmission condition satisfies the first condition or the third condition, the power control unit sets the power to be supplied to the antenna to the second power before a timing at which an operation of starting transmission of the captured image data to the another information processing apparatus is performed, and supplies the first or third power higher than the second power to the antenna after the timing.

15. A power control method comprising:
executing, by an imaging apparatus,
processing of performing wireless communication with another information processing apparatus using an antenna, and
processing of controlling power to be supplied to the antenna in accordance with a transmission condition of captured image data in the wireless communication.

16. A program for causing an imaging apparatus to execute:
processing of performing wireless communication with another information processing apparatus using an antenna; and
processing of controlling power to be supplied to the antenna in accordance with a transmission condition of captured image data in the wireless communication.
